(19) United States
(12) Patent Application Publication
(10) Pub. No.: US 2005/0221813 A1
(43) Pub. Date: Oct. 6, 2005

(54) System and method for initiating auxiliary communication interfaces via a primary communication interface

(76) Inventors: Jarno Rajahalme, Kirkkonummi (FI); Kari J. Leppanen, Helsinki (FI); Steven Deward Gray, Dallas, TX (US)

Correspondence Address: CRAWFORD MAUNU PLLC, 1270 NORTHLAND DRIVE, SUITE 390, ST. PAUL, MN, 55120, US

(21) Appl. No.: 10/818,176

(22) Filed: Apr. 5, 2004

(51) Int. Cl. H04Q 7/20; H04M 1/00

(52) U.S. Cl. 455/422.1; 455/426.1; 455/466

(57) ABSTRACT

A system, apparatus and method for utilizing a first communication interface(s) to initiate communications via a second communication interface(s). Auxiliary communication information is communicated from an initiating device to a target device(s) via a first over-the-air (OTA) communication interface. In response to the auxiliary communication information, an auxiliary communication module is activated at the target device for communication via a second OTA communication interface. The target device may then communicate with the initiating device and/or other devices via the second OTA communication interface.

### FIELD OF THE INVENTION

This invention relates in general to wireless communications, and more particularly to a system, method and apparatus for utilizing a first communication interface(s) to initiate communications via a second communication interface(s).

### BACKGROUND OF THE INVENTION

The proliferation of wireless communication devices evidences society's desire to be mobile and free of tethered use of computing and communication devices. The advent of the mobile phone and other wireless communication handsets has allowed users to communicate with one another while on the move. Cellular networks and other infrastructure-based networks allow such users to communicate with one another whether the users are within meters of one another, or on separate continents. When a user has his/her wireless communication device powered on, the device is typically in a “ready” state where it can receive calls at any time.

Wireless communications have also proved extremely valuable in non-infrastructure-based communications, such as in proximity networking environments. For example, computing systems may be wirelessly networked, such as with Wireless Local Area Networks (WLANs). Other short-range wireless communications are also becoming increasingly popular, such as communications via Bluetooth. With such short-range wireless communications, a wireless access point(s) is often utilized to coordinate the communications between devices within the transmission range of the wireless access point.

Short-range wireless communications such as WLAN and Bluetooth differ from infrastructure-based communications such as cellular communications in a number of ways. Cellular communications typically involve costs to the user, whether based on time usage, data transmission quantity, or the like. WLAN and Bluetooth, on the other hand, generally do not result in direct charges to the user based on time of use or transmission volumes. Further, short-range wireless communications may be controlled more closely to avoid network congestion problems. For example, two mobile device users engaged in a gaming session over a Bluetooth connection may avoid application delays that could otherwise adversely affect the session if conducted over a congestion-susceptible large-scale network. For these and other reasons, it is often desirable to communicate over short-range wireless networks rather than over large-scale networks such as cellular networks (which may implicate data networks such as the Internet, etc.).

To address such issues, mobile communication devices such as mobile phones that can communicate over cellular and other infrastructure-based networks are increasingly being equipped with auxiliary communication interfaces. For example, a mobile phone capable of communicating over a cellular network may be equipped with a Bluetooth and/or WLAN transceiver to allow communications via Bluetooth, WLAN, or other short-range wireless interface instead of, or in addition to, communication via the infrastructure-based communication interface. This provides users with flexibility in the manner of communicating with other users, as well as provides cost-effective communication alternatives.

However, some communication devices such as mobile devices are by nature limited devices compared to fixed and/or wired communication counterparts. For example, a mobile phone is intended to be a small, convenient communication tool that can be carried by users, and notwithstanding the obvious benefits of such devices, mobile devices do not share the screen size, memory capabilities, or power considerations as fixed computing/communication devices. Power consumption is of particular interest in mobile device design, as battery size and discharge characteristics (e.g., talk time, standby time, etc.) impact the convenience and usefulness of such mobile devices.

Mobile communication devices capable of infrastructure-based communications such as mobile phones may therefore be greatly enhanced by including one or more short-range wireless communications interfaces. However, each of these additional communications interfaces consumes valuable battery power, as such auxiliary communications interfaces may remain in a “listening” or paging mode, i.e., powered on and available for communicating at any time that the device itself is powered on. Thus, when such auxiliary communications interfaces are not actually in use, the circuitry associated therewith needlessly consumes valuable battery life.

A conventional manner for addressing such a problem is to provide the user with the ability to manually turn on an auxiliary communication module when prepared to use it. This solution, however, is not particularly convenient, and does not address the situation where the user's device is targeted for auxiliary communication initiated from another device. In other words, if the user has turned off his/her Bluetooth module, another user cannot initiate communications with that user via a Bluetooth connection.

Accordingly, there is a need in the wireless communication industry for a manner of conserving power on communication devices, while allowing for flexibility in the particular communication interface(s) that is to be utilized. A further need exists for a manner of providing the ability to selectively redirect communications from a first communication interface to a more desirable communication interface depending on the situation. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for utilizing a first communication interface(s) to initiate communications via a second communication interface(s). The present invention can thus provide infrastructure-assisted initiation of proximity or other auxiliary networking.

In accordance with one embodiment of the present invention, a method for communicating between devices is provided. The method includes communicating auxiliary communication information from an initiating device to a target device(s) via a first over-the-air (OTA) communication interface. In response to the auxiliary communication information, an auxiliary communication module is activated at the target device for communication via a second OTA communication interface. In accordance with another embodiment, the method includes communicating the auxiliary communication information via a first communication mode of an OTA communication interface, where an auxiliary communication mode is activated at the target device in response to the auxiliary communication information, where the target device then communicates via the auxiliary communication mode of the OTA communication interface.

According to more particular embodiments of such a method, the target device may then communicate with the initiating device and/or other devices via the second OTA communication interface. The first OTA communication interface may include, for example, a cellular network interface such as is used for mobile telephony, or other “default” communication interface that typically remains powered on and ready for communicating. The second OTA communication interface may include, for example, Bluetooth, WLAN, or other short-range and/or proximity network interfaces. In one embodiment, the auxiliary communication information includes instructions to the target device to turn on one or more auxiliary communication modules, or may include an invitation to the target device to initiate communications via a particular auxiliary communication interface(s).

In accordance with yet other particular embodiments of such a method, communicating the auxiliary communication information from the initiating device may be effected in a variety of manners. For example, the auxiliary communication instructions/invitation may be transmitted from the initiating device to the target device via one or more data link layer (e.g., layer-2) transmissions. More particularly, such information may be transmitted via Wireless Ethernet Media Access Control (MAC) sublayer transmissions, Bluetooth MAC sublayer transmissions, General Packet Radio Service (GPRS) Packet Data Protocol (PDP) transmissions, etc. The information may also be transmitted via internet layer transmissions, such as via IP packets and/or IP options associated with IP packets. The information may also be transmitted via messaging or signaling methodologies, such as via Short Message Service (SMS), Multimedia Messaging Service (MMS), Smart Messaging, Session Initiation Protocol (SIP), Instant Messaging (IM) protocol or service, presence sharing protocol, any application layer message, etc. In still other embodiments, parameters may be included in the auxiliary communication information. The parameters may include address information, location information, timing information, radio technology identification information, radio channel information, timeout information, security and authentication information, etc. Policies may also be applied at the target device to determine whether and how such auxiliary communication will be effected.

In accordance with another embodiment of the invention, a method is provided for facilitating network communications via a mobile device. The method includes receiving at least one message at the mobile device via an infrastructure-based or other default radio interface, where the message includes proximity communication information. The proximity communication information is identified at the mobile device, which in response enables a wireless proximity communication interface(s) for communication. The mobile device can then communicate wirelessly with at least one other communication device via the enabled wireless proximity communication interface.

In accordance with another embodiment of the invention, a communication device for communicating over-the-air (OTA) is provided. The communication device includes at least one default radio communication module configured for first wireless communication via a first radio communication interface. The communication device also includes at least one auxiliary radio communication module capable of effecting second wireless communication via a respective auxiliary radio communication interface. A processing module is configured to receive auxiliary communication information via the first radio communication interface, and to activate the auxiliary radio communication module identified by the auxiliary communication information for communication via the respective auxiliary radio communication interface.

In accordance with another embodiment of the invention, a network element is provided that is operable in a network for facilitating communication between at least first and second communication devices. The network element includes a receiver coupled to the first communication device via the network to receive auxiliary communication information from the first communication device according to a primary over-the-air (OTA) communication mode. The auxiliary communication information represents an invitation from the first communication device targeted for the second communication device to activate an auxiliary OTA communication mode for communication therebetween. The network element includes a transmitter coupled to the second communication device via the network to transmit the auxiliary communication information to the second communication device according to the primary OTA communication mode. The first and second communication devices are enabled for communication according to the auxiliary OTA communication mode in response to the second communication device receiving the auxiliary communication information.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating an exemplary embodiment for providing infrastructure-assisted initiation of auxiliary network communications in accordance with the present invention;

FIG. 2 is a block diagram illustrating a more particular embodiment of default interface-assisted initiation of auxiliary network communications in accordance with the present invention;

FIG. 3 is a block diagram generally illustrating one embodiment of a target peer device capable of communicating via a first communication interface to activate one or more auxiliary communication interfaces in accordance with the present invention;

FIG. 4 is a diagram illustrating an embodiment involving the exchange of parameters between the peers as part of the message exchange to initiate the auxiliary mode of operation;

FIG. 5 is a flow diagram illustrating a representative method for initiating proximity or auxiliary networking communications via a primary and/or infrastructure-assisted connection in accordance with one embodiment of the invention;

FIG. 6 is a flow diagram illustrating another exemplary method for initiating auxiliary radio communications via a primary/default radio interface;

FIG. 7 is a flow diagram illustrating a representative method for initiating proximity or auxiliary networking communications at a target device in accordance with one embodiment of the invention;

FIG. 8 is a flow diagram illustrating a representative method for initiating auxiliary radio communications via a primary/default radio interface and utilizing policies and/or parameters in accordance with one embodiment of the present invention; and

FIG. 9 illustrates a block diagram of a representative mobile device employing principles of the present invention.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a system, apparatus and method for facilitating communication between communication devices. Information is wirelessly communicated between devices over a first communication interface, such as via a cellular network. Thus, a first device may send a message(s) or other information packet(s) to one or more target devices, where such message, packet, or other information block includes a request or invitation to communicate via a different wireless communication mechanism. In response to such a request/invitation provided via the first communication interface, the target device can power on or otherwise activate the identified wireless communication mechanism to thereafter engage in communication via a second communication interface(s).

As an example, an initiating device may send a message to a target device via a cellular network, such as by sending a Short Message Service (SMS) message(s) that includes a request or other instructions to the target device to communicate with the initiating device via a Wireless Local Area Network (WLAN). The target device receives the SMS message, and in response powers on, or otherwise activates or enables for communication, its WLAN module. The target device can then “listen” or otherwise remain prepared for communication with the initiating device via the WLAN, or may itself initiate the communication with the initiating device via the WLAN. In this manner, a first communication channel (e.g., cellular network) is used to cause the target device to activate a second communication channel (e.g., WLAN, Bluetooth, etc.) for subsequent communication with the initiating device. This example is merely representative of a manner in which the present invention may be utilized, and various embodiments are described in greater detail below.

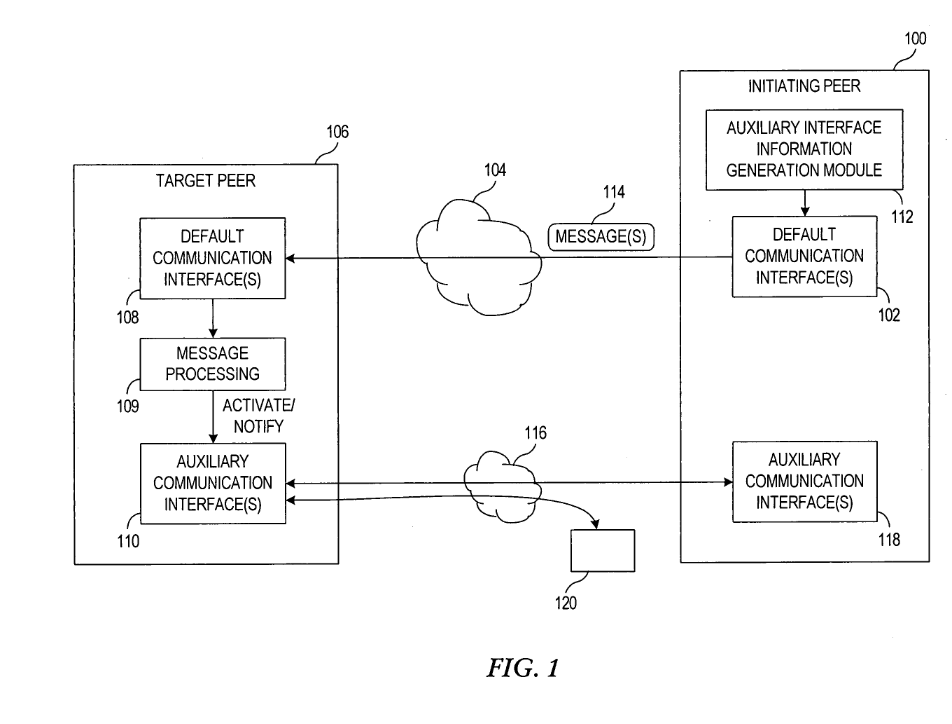

FIG. 1 is a block diagram illustrating an exemplary embodiment for providing infrastructure-assisted initiation of auxiliary network communications in accordance with the present invention. In accordance with the invention, one or more proximity or other auxiliary modes of networking may be initiated using one or more infrastructure-assisted or default radio interfaces. In one embodiment, the use of a first radio interface(s) to initiate an auxiliary radio interface(s) obviates the need for the auxiliary radio interface to remain in a state (e.g., a listening mode) to remain prepared to communicate via the auxiliary radio interface. In some cases, it may be beneficial to use the auxiliary radio interface(s) instead of, or in addition to, the primary/default radio interface. Further, decisions can be made as to whether the auxiliary radio interface(s) will make itself available for particular communications, thereby providing a communication filtering function. Various parameters can be exchanged to determine whether, when and/or how such communications via the auxiliary radio interface will occur.

Referring to FIG. 1, an initiating peer device 100 includes a default communication interface 102, such as a cellular radio interface for communicating information over a cellular network 104. It should be noted that the terms “default” communication interface and “primary” communication interface are used interchangeably herein. The cellular network 104 includes any currently known or future cellular network(s), such as Global System for Mobile communication (GSM), Personal Communications Services (PCS), Code Division Multiple Access (CDMA), Time Division Multiple Access (TDMA), etc.

The cellular radio interface is merely representative of the default communication interface(s) 102 that may be used in connection with the present invention. In one embodiment of the invention, the default communication/radio interface 102 represents a radio interface that typically remains turned on or otherwise prepared to communicate at any time when the device 100 is powered on. One such default radio interface is an infrastructure-based cellular radio interface, or a particular mode of operation of such a radio interface. For purposes of the description of FIG. 1, the default communication interface 102 is assumed to represent a cellular radio interface.

The default radio interface 102 of the initiating peer device 100 communicates information over the interface, an infrastructure-based cellular radio interface in the illustrated embodiment, to the target peer(s) 106. The target peer 106 includes a default communication interface 108, which represents a cellular radio interface in the illustrated embodiment. The information communicated by the initiating peer device 100 to the target peer device 106 includes information related to proposed communication via one or more auxiliary communication interfaces 110 of the target peer 106. Using this information received via a first communication interface (i.e., the default communication interface), the auxiliary communication interface(s) 110 may be initiated for communication or otherwise notified of invitations for communication via the auxiliary communication interface 110.

In a more particular embodiment, the initiating peer 100 includes an auxiliary interface information generation module 112 operating over the default communication interface 102 to communicate the information over the interface to the target peer(s) 106. This module 112 generates a message or otherwise produces the information for transfer to the target peer(s) 106 via the default communication interface 102. In one embodiment, the information is provided via one or more messages 114 that are transmitted over the network 104 via the default communication interfaces 102, 108 of the initiating and target peers 100, 106. The message(s) 114 may include, for example, information to instruct the target peer(s) 106 to turn on an auxiliary radio interface 110, or an auxiliary mode of the default radio interface 108 such as an infrastructure-less mode of the default radio interface 108. Such an instruction to turn on the auxiliary radio interface 110 may be used by the target peer 106 to turn on one or more auxiliary radio interfaces 110 to listen for incoming connections over an auxiliary network 116 via the auxiliary radio interface 110. The message(s) 114 may instead, or in addition, notify the target peer 106 that the initiating peer 100 is in listening mode on a particular radio interface(s) 118 and invite the target peer(s) 106 to establish radio communication to the initiating peer 100 via that radio interface(s) 118, and possibly to other peers 120. Additionally, the auxiliary radio interface 110 can connect to a mesh of radio interfaces, enabling multi-hop (i.e., ad-hoc) communication between the peers 100, 106 to be initiated by the message(s) 114. More particularly, the auxiliary radio interface 110 may include peer-to-peer connections over an ad-hoc network of nodes, wherein the communication is transmitted over multiple hops and one or more types of radio interfaces.

The message 114 or other information exchange to initiate the auxiliary radio interface 110, 118 communications may be instigated by an action of the user of the initiating device 100, or automatically by a program on the device 100. For example, a user may initiate transfer of the message(s) 114 via a user interface (UI) available on the device 100. Such user interface may include, for example, text entry, graphical user interface (GUI), device buttons or other mechanical selectors, voice commands, touch screen, etc. In another embodiment, particular triggering events may cause a program(s) on the initiating peer 100 device to automatically send the message(s) 114 to the target peer(s) 106. For example, invoking a particular program on the initiating device 100 may automatically communicate the message(s) 114. Any other defined triggering event may similarly cause automatic communication of the message(s) 114, such as a particular time, date, location of the initiating 100 and/or target 106 peer, user action on the initiating peer 100, etc. Similarly, activity at the target peer 106 to engage in communication via the auxiliary communication interface(s) 110 may be initiated automatically by a program on the target device 106, or manually by the user of the target device 106. For example, the target device 106 user may be notified that a request for auxiliary communication is desired, and the user may then manually activate the auxiliary communication interface(s) or the auxiliary communication interface(s) may be automatically invoked.

Transmission of the message(s) 114 involves utilization of the infrastructure and addressing capabilities of the default radio interface to initially address the target peer(s) 106, and to perform the message exchange with the target peer(s) 106. In accordance with one embodiment of the invention, communication between the peers 100, 106 does not have to wait for the establishment of the communication via the auxiliary radio interfaces 110, 118, but rather the communication can initially utilize the default radio interfaces 102, 108. The message 114 to initiate the auxiliary mode of operation may be sent first from the initiating peer 100, and then initially communicate via the default radio interfaces 102, 108 until the auxiliary radio interface 110 on the target peer 106 is activated and ready to communicate. Alternatively, the message 114 to initiate the auxiliary mode of operation can be sent intermixed with the application traffic, either as a separate message (or packet), or the message 114 initiating the auxiliary mode of operation can be included in some other message being exchanged between the peers 100, 106.

In accordance with one embodiment of the invention, the message(s) 114 are received at the target peer 106 via the default communication interface(s) 108, where the message is processed via the message processing module 109. For example, the message(s) may be parsed to identify the instructions and/or parameters provided via the message(s) 114. Using this information, the target peer 106 may activate one or more auxiliary communication interfaces 110, or may otherwise prepare the auxiliary communication interfaces 110 for communication with the initiating peer 100 and/or other devices (e.g., device 120) via the auxiliary network 116.

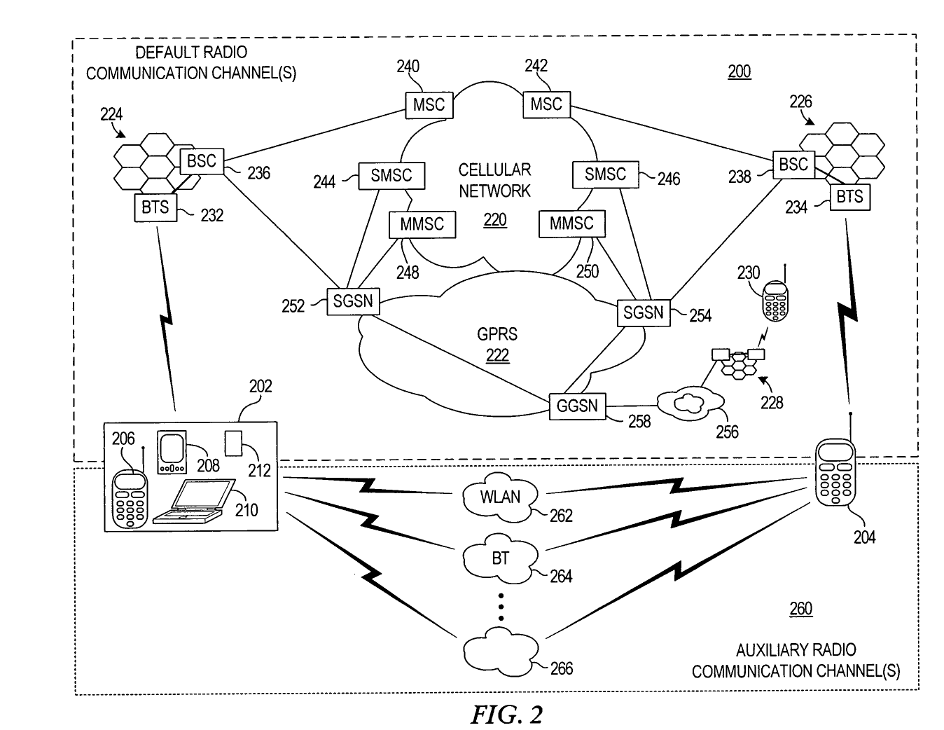

FIG. 2 is a block diagram illustrating a more particular embodiment of a default communication interface-assisted initiation of auxiliary network communications in accordance with the present invention. At least one primary/default radio communication channel 200 is provided for communication between the terminals and/or mobile devices that are to communicate with one another. In the illustrated embodiment, the communicating devices include mobile devices 202, 204, each of which can communicate via a default radio communication channel(s) 200. The communicating devices may include mobile devices and/or fixed mobile devices capable of communicating over-the-air (OTA). In the illustrated embodiment, the communicating devices 202, 204 are represented as mobile devices. The communicating devices 202, 204 may be, for example, mobile phones 206, Personal Digital Assistants (PDAs) 208, mobile computing devices 210 such as laptop/notebook computers, and other mobile or fixed wireless devices 212 capable of communicating OTA, as represented at communication device 202.

In the illustrated embodiment, the default communication channel 200 may is represented by any number of infrastructure-based communication networks, such as a cellular network 220 which may or may not include associated data networks such as a General Packet Radio Service (GPRS) network 222. The cellular network 220 represents any type of cellular network, such as the Global System for Mobile Communication (GSM), Personal Communications Services (PCS), Personal Digital Cellular (PDC), Code Division Multiple Access (CDMA), Time Division Multiple Access (CDMA), or the like. For purposes of discussion, the cellular network 220 is described in terms of a GSM network. A GSM network may include various Base Station Subsystems (BSS) 224, 226, 228, etc. These BSSs provide wireless access for devices 202, 204, 230 to access the cellular network 220, GPRS network 222, and/or data networks such as the Internet, IP Multimedia Subsystem (IMS), etc. The BSSs include, for example, Base Station Transceivers (BTS) 232, 234 to which the mobile devices 202, 204 respectively communicate, as well as Base Station Controllers (BSC) 236, 238 that communicate with associated BTSs. The BSCs 236, 238 may respectively communicate with switching system components such as Mobile Switching Centers (MSC) 240, 242 which in turn may be associated with databases such as a Home Location Register (HLR) and Visiting Location Register (VLR) (not shown).

Other components may also be associated with the cellular network 220, to facilitate messaging technologies. For example, Short Message Service (SMS), Multimedia Messaging Service (MMS), e-mail, and/or other messaging may be accomplished via the cellular network 220. SMS and MMS represent store-and-forward messaging technologies, where messages are transmitted to respective SMS Centers (SMSC) 244, 246 or MMS Centers (MMSC) 248, 250 as is known in the art. In GPRS network 222 environments, communication through the GPRS network 222 is facilitated by an interface device such as Serving GPRS Support Node (SGSN) 252, 254, and one or more Gateway GPRS Support Nodes (GGSN) 258.

In other embodiments, the default radio communication channel 200 may include communication mechanisms that are not cellular based. For example, any communication interface that typically remains in an “on” or active state may be used as the default communication channel, such that the default communication channel(s) can notify one or more of the auxiliary communication channels that communication via that auxiliary communication channel is desired.

In accordance with the present invention, a first device 204 may want to notify a second device 202 that communication via an auxiliary radio communication channel(s) 220 is desired. Using GSM as a representative network environment for the default radio communication channels 200, a message or other information transfer can be sent from the mobile device 204 to the mobile device 202 via the default radio communication channels 200. For example, a message may be sent via the GSM or other cellular network 220 infrastructure, and/or GPRS network 222 which allows support of packet-based communications in evolved GSM networks.

Any number of transports available on the default radio interface may be used to communicate a message(s) to initiate auxiliary radio communications in accordance with the invention. For example, the transport may include layer-2 (L2) framing such as Wireless Ethernet Media Access Control (MAC) sublayer, Bluetooth MAC, etc. Layer-2 framing generally refers to framing at the data link layer, where a stream of physical layer bits is broken into discrete segments or “frames.” The auxiliary radio communication initiation messages in accordance with the present invention may be communicated via such layer-2 MAC sublayer transports. The auxiliary radio communication initiation message(s) may also be communicated between GPRS Support Nodes (GSNs), such as between GGSNs and/or SGSNs, using a GPRS Packet Data Protocol (PDP) message(s) where a GPRS network 222 is employed. In yet another example, the auxiliary information may be included in user data packets carried by way of the GPRS Tunneling Protocol (GTP). For example, the auxiliary information may be carried in Internet Protocol (IP), X.25, or other analogous packets that are transmitted encapsulated within the GPRS backbone network using the GTP.

The auxiliary radio communication initiation message(s) may also be transmitted using other transports, such as via an IP packet, or included in an IP packet as an IP option (IPv4, IPv6, etc.). As used herein, “IP packet transmissions” include transmissions via IP, whether IPv4, IPv6, or any other current or future IP variation. The message may also be transmitted via other message formats, such as in Session Initiation Protocol (SIP) methods, Short Message Service (SMS) message, Multimedia Messaging Service (MMS) message, or any other form of message exchange being utilized between the peers 202, 204. For example, SIP includes methods such as INVITE, REGISTER, NOTIFY, INFO, and other methods in which the auxiliary radio communication initiation message(s) may be communicated. Further, the session description of the auxiliary radio interfaces may be added to the Session Description Protocol (SDP) carried by SIP messages, where the SDP is a protocol generally used for describing multimedia sessions for the purposes of session announcement, session invitation, and other forms of session initiation.

Optionally, the parameters being exchanged between the peers as part of the message exchange to initiate the auxiliary mode of operation may include addressing information of the peers, such as L2, IP, or SIP addresses of the peers. This addressing information may be used to, for example, establish routes between the peers and directing the traffic between the peers to be transmitted over the auxiliary radio interface when set up.

As a representative example, an SMS message(s) may be communicated to initiate a communication session over an auxiliary interface. The mobile device 204 generates at least one SMS message to transfer to the target device 202 via the SMSCs 244, 246 over the cellular network 220. More particularly, the device 204 may transmit an SMS message OTA to its BTS 234, and the associated Base Station Controller (BSC) 238 provides the SMS message to the SMSC 246. Communication of the SMS message may be effected via the MSC 242, via an SGSN 254, or otherwise. The SMSC 246 directs the SMS message to the SMSC 244 associated with the target device 202 (unless both devices 204, 202 are associated with the same SMSC). The SMS message is ultimately received at the target device 202, where the message can be parsed to identify the auxiliary communication information that indicates that communication via an auxiliary radio communication channel 260 is desired. In response, the target device 202 powers on or otherwise activates the appropriate auxiliary radio communication module (not shown) to effect further communication via such auxiliary radio channel. For example, such auxiliary radio communications may be effected via a Wireless Local Area Network (WLAN) 262, Bluetooth network 264, or other wireless technology 266. Such other wireless communication technologies may include any short-range wireless transmission technology. For example, it may be desirable to utilize a wireless transmission technology that is in an unlicensed frequency spectrum, or that does not involve costs associated with time of use and/or data transfer quantities, or that is less susceptible to network congestion, etc. In one embodiment, the default communication interface includes a communication interface in which OTA communication is effected via a portion of a licensed frequency spectrum, and an auxiliary OTA communication interface includes a communication interface in which OTA communication is effected via a non-licensed frequency spectrum. Even technologies such as infrared transmission may be used as an auxiliary radio communication channel 260 under the right circumstances.

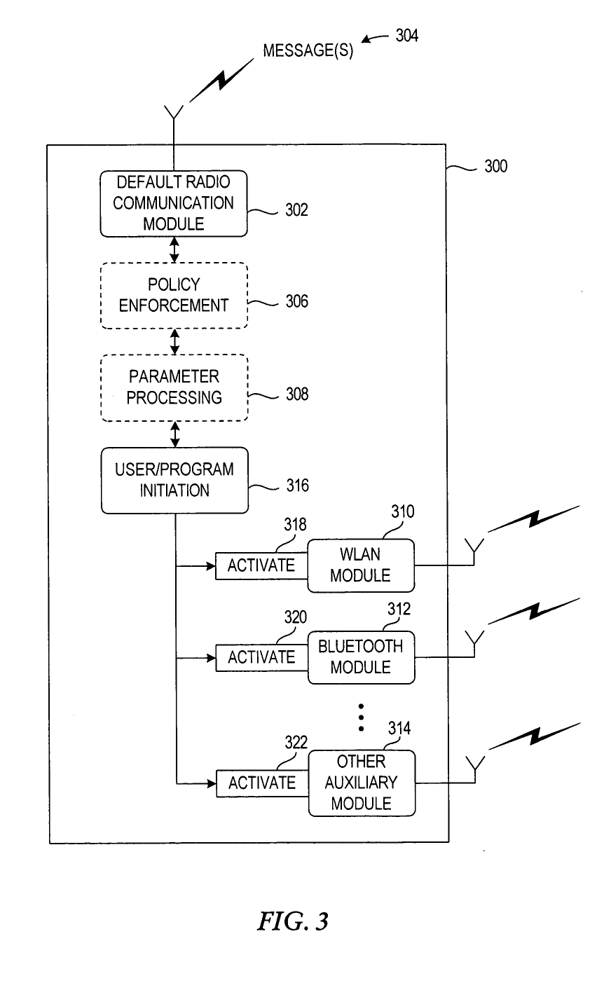

FIG. 3 is a block diagram generally illustrating one embodiment of a target peer device 300 capable of communicating via a first communication interface to activate one or more auxiliary communication interfaces in accordance with the present invention. In the illustrated embodiment, the device 300 represents a wireless communication device, such as a mobile phone, Personal Digital Assistant (PDA), wireless computing device, or other device/communicator capable of communicating via wireless networks and/or interfaces. The device 300 may also represent a fixed wireless device, such as a computing system or other communicator in a fixed location and deriving electrical power from fixed utility sources, yet having wireless communication capabilities such as cellular communication capabilities and WLAN/Bluetooth capabilities.

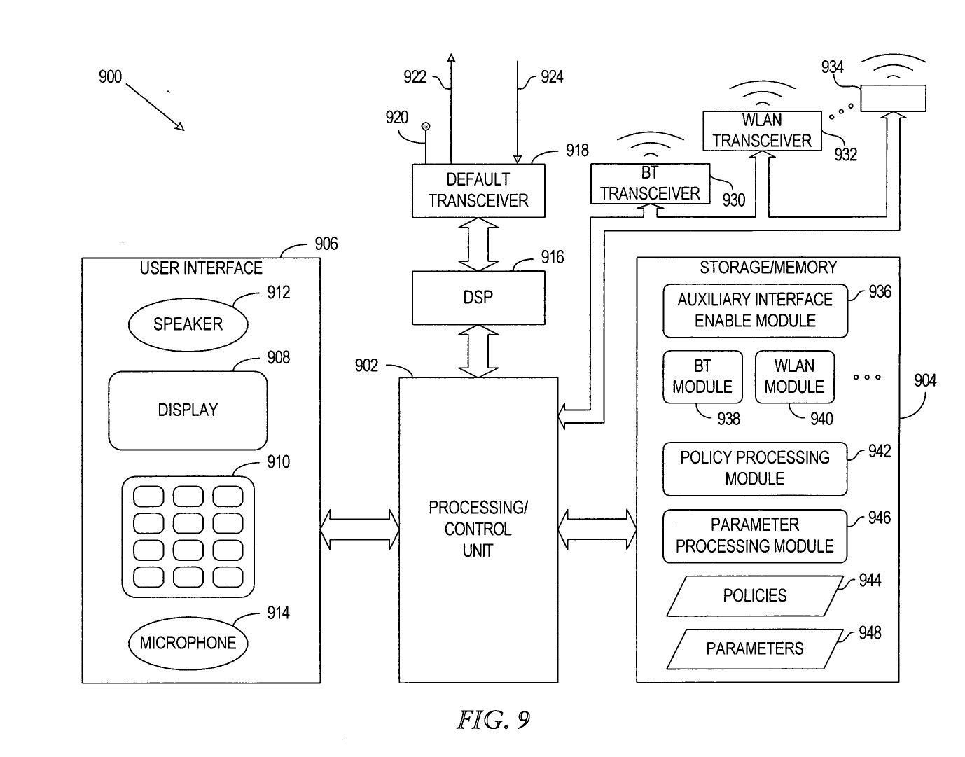

The mobile device 300 includes a first communication interface module, shown in FIG. 3 as the default radio communication module 302. The module 302 represents a first radio communication interface, such as a cellular radio interface. In the illustrated embodiment, this first radio communication interface 302 refers to a radio interface or mode of operation of a radio interface that is normally maintained in an “on” state when the device 300 itself is powered on, so that communications may be received at any time. In one embodiment, this first radio interface(s) is referred to as the “default” radio communication interface, as it serves as a default means of communication. The default radio communication module 302 may include the hardware and/or software required to carry out such communications. For example, the mobile device 300 may be equipped with a processor, transceiver, program instructions, and the like to carry out the desired communications. A more particular embodiment of a mobile device or other communication device capable of carrying out such communications, such as radio communications over a cellular network, is described in greater detail in connection with FIG. 9.

In accordance with one embodiment of the present invention, one or more messages 304 are received at the mobile device 300 at the default radio communication module 302. These messages 304 may be provided in any number of available manners, such as via layer-2 framing such as Wireless Ethernet or Bluetooth MAC, GPRS PDP messages, IP packets or included in an IP packet as an IP option, an SMS message, or any other form of message exchange being utilized between the communicating peers.

Upon receiving the message(s) 304 in accordance with one embodiment, the device 300 may optionally enforce policies via the policy enforcement module 306. Such policies may provide guidelines for action by the device 300 depending on the instructions provided via the message(s) 304. For example, assume the instructions provided via a message 304 request the device 300 to start an auxiliary communication interface to engage in proximity networking with one or more other devices. The device 300 may include policies to prohibit such auxiliary radio communications if certain conditions are/are not met, and/or the device 300 is not compatible with the capabilities required for the auxiliary mode of operation as communicated by the initiating peer. In such cases, the policy enforcement module 306 can apply the established policies to continue communicating via the default radio communication module 302. For example, a policy may be in place that indicates that a real-time gaming session is continued only if an auxiliary radio interface utilizing an infrastructure-less mode of operation can be utilized, such as communication via WLAN or Bluetooth. As another example, a policy may indicate that transmission of a message including one or more images is continued over the default radio interface if an auxiliary mode cannot be opened. Yet another exemplary policy may be to automatically communicate via a WLAN with the initiating peer and/or other devices whenever the instructions of the message request WLAN communication. Any desired policies may be implemented via such a policy enforcement module 306.

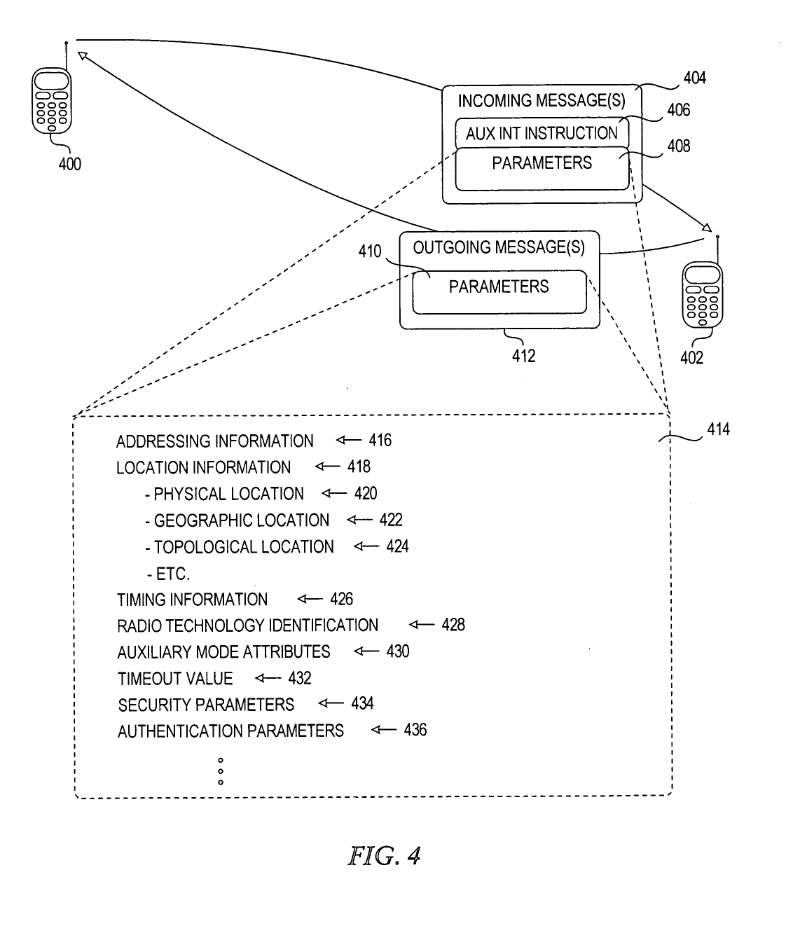

In accordance with one embodiment of the invention, parameters may be exchanged between the peers as part of the message exchange to initiate the auxiliary mode of operation. These parameters may include, for example, addressing information of the peers, location information, timing information, radio technology identification, auxiliary mode attributes, timeout values, security/authentication parameters, etc. More particular examples of such parameters are described in connection with FIG. 4. Such parameters may be processed via the parameter processing module 308.

Based on the information provided via the message(s) 304, one or more resident auxiliary radio communication modules 310, 312, 314 may be activated. Such an attempt to activate one or more auxiliary radio communication modules may be initiated by the user of the device 300, or initiated via a program in response to a triggering event such as receipt of the message 304. This is depicted via the user/program initiation block 316. Depending on the information provided via the message(s) 304, and optionally depending on particular policies and/or parameters, one or more of the auxiliary radio communication modules 310, 312, 314 may be activated for communication. For example, a message 304 may request the device 300 to communicate with the initiating peer via a Wireless Local Area Network (WLAN), in which case the WLAN module 310 may be activated. In one embodiment, activation of such a module involves enabling power to the WLAN module 310 via a power enable module/circuit, depicted at the activate module 318. As a more particular example, the information associated with the message 304 may cause an activate circuit 318 to apply power to the WLAN module 310, and to configure the WLAN module 310 for communication with the initiating peer and/or other devices via the WLAN. By powering on the WLAN module 310, the device 300 can be configured to listen for incoming communications via the WLAN, and/or may initiate WLAN communications itself. In this manner, energy is not wasted by continuously providing power to the WLAN module 310 until such time that communications via the WLAN is requested or otherwise desired. In another embodiment, the WLAN module 310 may be “powered on” to some extent, but not fully powered to enable communication. In such a case, activation of the module involves “enabling for communication” the WLAN module 310, such as by powering on the relevant portion(s) of the WLAN module 310 required to engage in the auxiliary communication.

The device 300 may include one or more auxiliary radio communication interfaces. Another exemplary auxiliary radio communication module depicted in FIG. 3 is a Bluetooth module 312. If communications via Bluetooth is desired, the Bluetooth module 312 may be activated 320 in a manner analogous to that described above. Any other short-range radio interface, and/or infrastructure-less radio interface, and/or peer-to-peer radio interface, or the like may be employed, as depicted by auxiliary module 314. Such a module 314 is activated 322 when the message(s) 304 identify the particular auxiliary radio interface as the designated or preferred communication means, as previously described. The auxiliary module 314 may also be identified based on, for example, addressing information if not otherwise explicitly identified.

As can be seen from the foregoing example, infrastructure-less or proximity (e.g., peer-to-peer) communications can be initiated only when needed/desired, without having to continually provide power to such auxiliary radio interfaces, or at least without having to keep all parts of the auxiliary radio interfaces powered on. Keeping such additional radio interfaces perpetually prepared for incoming connections wastes energy when the respective additional radio interface is not being used for active communications. Thus, in accordance with one embodiment of the invention, the auxiliary radio interface(s) or communication modes (or particular portions related to the communication) may be switched on when ready for active use, and otherwise be switched off to conserve energy. Further, providing such control over auxiliary radio communications allows communications to be diverted from an infrastructure-based radio communication interface (e.g., cellular network) to an infrastructure-less or peer-to-peer network (e.g., WLAN, Bluetooth, etc.) when desired, which can conserve on infrastructure-based network usage which may be more costly, less responsive or reliable due to network congestion and/or signal strength, and/or which may allow the infrastructure-based network to serve more customers.

The message(s) to initiate the auxiliary radio interface(s) at the target device may therefore utilize the infrastructure and addressing capabilities of a primary/default radio interface to initially address the peer, and to perform the message exchange with the peer. This message exchange may involve the exchange of various parameters, as previously described. These parameters may include, for example, addressing information of the peers, location information, timing information, radio technology identification information, auxiliary mode attributes, timeout values, security/authentication information, and the like. FIG. 4 illustrates the exchange of such parameters in accordance with one embodiment of the invention.

In the embodiment illustrated in FIG. 4, two mobile devices 400, 402 are configured to communicate at least via a first radio communication interface, such as via a cellular network. The mobile devices 400, 402 are illustrated as mobile phones, although either or both mobile devices 400, 402 may be other types of mobile devices, such as PDAs, portable computing devices, or other mobile communication devices capable of communicating via at least one primary/default radio communication interface and at least one auxiliary radio communication interface. Further, it should be recognized that in one embodiment, the initiating device may not include auxiliary radio interfaces, but rather may include only a primary/default radio communication interface such as a cellular telephony interface. In such an embodiment, the initiating device (e.g., device 400) may contact one or more target devices (e.g., device 402) to notify the target device 402 to enable one or more auxiliary radio communication interfaces, where the target device 402 then communicates with devices other than the initiating device 400 using the auxiliary radio communication interface(s).

The initiating mobile device 400 sends at least one message 404, which is an incoming message to the target mobile device 402. The message(s) 404 may include auxiliary interface instructions 406, such as information to instruct the target device 402 to turn on or otherwise enable an auxiliary radio communication interface(s), or to invite the target device 402 to initiate auxiliary radio communications with the initiating device 400 and/or other devices. One or more parameters 408 may be included in the incoming message 404 to the target device 402. Further, the target device 402 may exchange parameters with the initiating device 400 by sending one or more outgoing messages 410 which include particular parameters 412. In this manner, the initiating and target devices 400, 402 may exchange parameters to establish the desired auxiliary radio communications.

The parameters 408, 412 associated with the messages 404, 410 may include various types of parameters, as depicted by parameter block 414. The parameters shown at parameter block 414 identify representative parameters, one or more of which may be exchanged between the initiating and target devices 400, 402. However, it should be recognized that the present invention is equally applicable to different parameters than those shown in FIG. 4. The parameters described in connection with FIG. 4 are described for purposes of illustration, and the invention is clearly not limited to the specific examples described in connection with FIG. 4.

A first representative parameter includes addressing information 416. Optionally, the parameters being exchanged between the peers as part of the message 404, 410 exchange to initiate the auxiliary mode of operation may include addressing information 416 of the peers (i.e., devices 400, 402 in the illustrated embodiment). Such addressing information may include layer-2 addresses, IP addresses, Session Initiation Protocol (SIP) addresses, or other addresses of the peers. This addressing information may be used, for example, to establish routes between the peers, and/or for directing the traffic between the peers to be transmitted over the auxiliary radio interface when the auxiliary radio interface has been established.

Another representative parameter includes location information 418. Optionally, the parameters being exchanged between the peers as part of the message 404, 410 exchange to initiate the auxiliary mode of operation may include location information 418 regarding the communicating peers 400, 402. The location information may, for example, indicate one or more properties of the physical location 420, geographical location 422, and/or topological location 424 of one or more of the peers 400, 402. For example, physical location information 420 may represent the identity of a space in which the peers are occupants, such as a region, campus, building, physical address, etc. Geographical location information 422 may be represented by geographic coordinates having some defined or desired level of accuracy. For example, geographic location may be determined using longitudes and latitudes, Global Positioning Systems (GPS), or other geographic locator method or technology. Location information may include topological location information 424 in relation to either the default radio interface, auxiliary radio interface, or some other topology that the peers 400, 402 expect to share (e.g., cell identity of a radio interface). The location information 418 can also be formed of any combination of the different location information types 420, 422, 424 described above and/or other location information types. This location information can be used, for example, to prevent unnecessary attempts to initiate the auxiliary mode of communication.

Another representative parameter includes timing information 426. Optionally, the parameters being exchanged between the peers as part of the message 404, 410 exchange to initiate the auxiliary mode of operation may include timing information 426, enabling more efficient start-up of the auxiliary mode of operation. For example, the timing information may enable faster synchronization of the auxiliary mode of operation, or otherwise assist in the initiation of the auxiliary radio communication.

Yet another representative parameter includes radio technology identification information 428. Optionally, the parameters being exchanged between the peers as part of the message 404, 410 exchange to initiate the auxiliary mode of operation may include identification of the radio technology being utilized for the auxiliary mode of operation. For example, this information may identify IEEE 802.1, Bluetooth, or other radio technology in which auxiliary communication is desired. This allows, for example, receiving peer 402 to quickly determine whether it is compatible with the request of the initiating peer 400.

Auxiliary mode attributes 430 may also be exchanged as message parameters. Optionally, the parameters being exchanged between the peers as part of the message 404, 410 exchange to initiate the auxiliary mode of operation may include any set of parameters that enables the peers 400, 402 to quickly start the auxiliary mode of operation without unnecessarily expending time testing or monitoring parameter values to identify the most effective or otherwise desired parameter values. For example, the auxiliary mode attributes 430 may include sets of parameters such as channel number, channel coding type, or the like, which may enable the peers to more efficiently and/or effectively start the auxiliary mode of operation. Otherwise, time may be wasted in trying out various parameter values unnecessarily, such as by scanning through a set of radio channels to determine which channel the other peer is using, etc.

Another representative parameter may include a timeout value 432. Optionally, the parameters being exchanged between the peers as part of the message 404, 410 exchange to initiate the auxiliary mode of operation may include a timeout value 432 that can assist in auxiliary radio communication matters. For example, a parameter may include a timeout value to identify an allowable time duration for attempting communication via a particular one or more of the auxiliary radio communication modules. Expiration of such a timeout value indicates that the peer(s) assumes cannot communicate using the auxiliary mode of operation, thereby allowing the peer(s) to stop further attempts to establish the connection of the auxiliary mode of operation, which can waste energy and otherwise prove inefficient.

Security parameters 434 and/or authentication parameters 436 may also be provided in the message exchange. Optionally, these parameters associated with the message(s) being exchanged to initiate the auxiliary mode of operation may be utilized on or over the auxiliary mode of operation. For example, these parameters may be used to secure the communications over the auxiliary radio interface, to authenticate the peer over the auxiliary radio interface, etc.

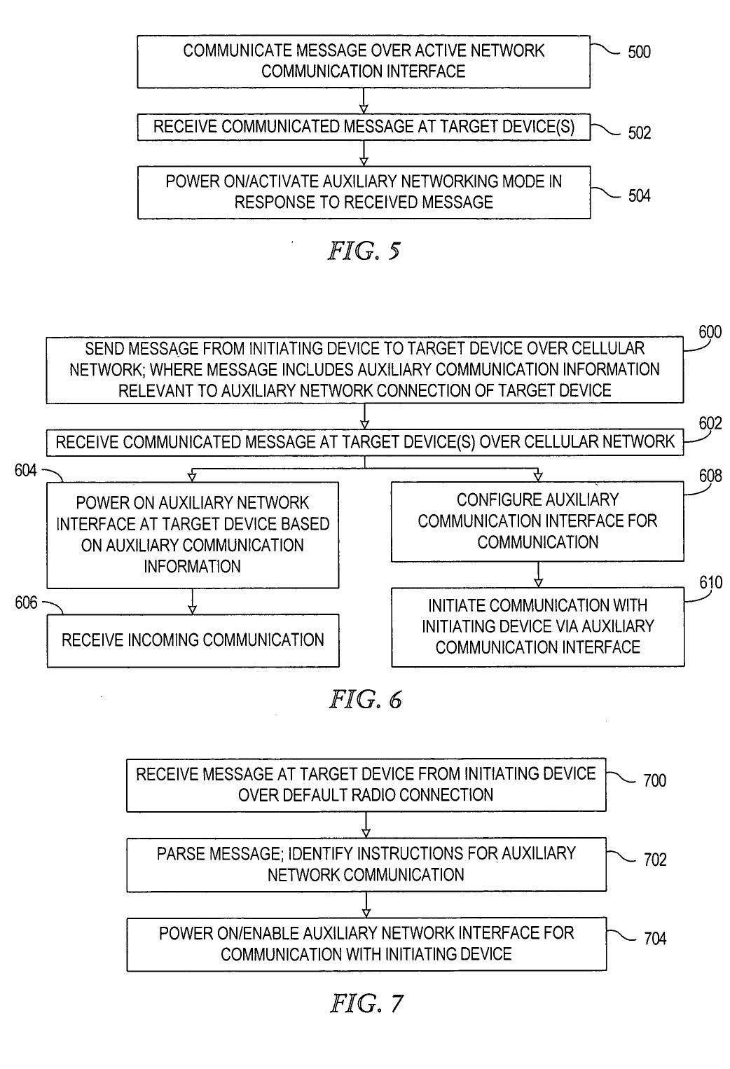

The message exchange using a primary/default radio communication interface therefore enables proximity networking or other auxiliary networking mode to be initiated when needed, without the auxiliary radio interface continuously being on—e.g., in a listening mode or otherwise ready to receive communications via the proximity or other auxiliary networking mode. Using the present invention, auxiliary radio communications may be initiated when needed, using a radio communication interface that is already prepared to receive communications. This aspect of the invention is generally illustrated in FIG. 5, which illustrates a flow diagram of a method for initiating proximity or auxiliary networking communications via a primary and/or infrastructure-assisted connection. One or more messages are communicated 500 over an active network communication interface, such as a cellular network connection. The message is received 502 at one or more target devices, and the auxiliary networking mode at the target device(s) is powered on or otherwise activated in response to the received message as shown at block 504.

FIG. 6 illustrates another method for initiating auxiliary radio communications via a primary/default radio interface. In the illustrated embodiment, one or more messages are sent 600 from an initiating device to one or more target devices over a cellular network, where the message includes auxiliary communication information relevant to establishing an auxiliary network connection at the target device. The message(s) is received 602 at the target device(s) over the cellular network. In one embodiment illustrated at block 604, at least one auxiliary network interface is powered on or otherwise enabled for communication at the target device, based on the auxiliary communication information provided via the cellular network. Once powered on, the target device (or the relevant communication circuitry) stands prepared to receive 606 incoming communications via the enabled auxiliary communication interface. In another embodiment, the message(s) received 602 at the target device may result in the identified auxiliary radio communication interface at the target device being configured 608 for communication, where the target device may then initiate 610 communication with the initiating device (and/or other devices) via the identified auxiliary radio communication interface.

In accordance with one embodiment, messages are received at the target device from the initiating device over a default radio connection, as shown at block 700 of FIG. 7. The target device may parse 702 the message to identify the instructions for performing auxiliary network communication. The auxiliary network interface at the target device is powered on or otherwise enabled for communication with the initiating device, as shown at block 704.

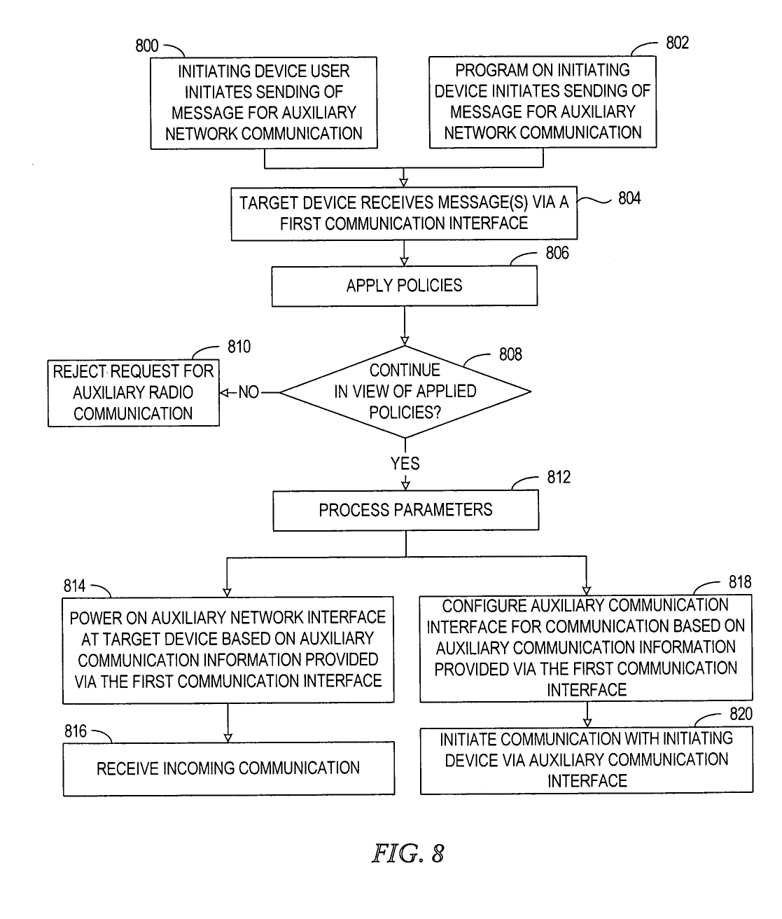

FIG. 8 illustrates yet another embodiment of a method for initiating auxiliary radio communications via a primary/default radio interface in accordance with the principles of the present invention. The user of the initiating device may initiate 800 sending of a message(s) to engage in communication via an auxiliary radio interface. Alternatively, a program on the initiating device may automatically initiate 802 sending of the message(s) for auxiliary network communication. One or more target devices receive 804 the message(s) via a first communication interface, such as a cellular network interface. Policies may optionally be applied 806 at the target device(s), such that decisions based on such policies can be made to determine whether or how such auxiliary network communications will be effected. If it is determined 808 that auxiliary network communications will not be conducted, the request for auxiliary radio communication will be rejected 810. Otherwise, the process continues, where parameters associated with the message(s) may be exchanged and processed as shown at block 812. In one embodiment, at least one auxiliary network interface is powered on 814 at the target device, based on the auxiliary communication information provided via the first communication interface. When the auxiliary communication interface has been powered on, the target device stands prepared to receive 816 incoming communications via the enabled auxiliary communication interface. In another embodiment, the message(s) received at the target device result in the identified auxiliary radio communication interface at the target device being configured 818 for communication, based on the information provided via the first communication interface. The target device may then initiate 820 communication with the initiating device (and/or other devices) via the identified auxiliary radio communication interface.

Hardware, firmware, software or a combination thereof may be used to perform the functions and operations at the mobile devices in accordance with the invention. The mobile devices in accordance with the invention include communication devices capable of engaging in at least one default radio connection, and at least one auxiliary radio connection. These devices include, for example, mobile phones, PDAs, and other wireless communication devices, as well as landline computing systems and communication systems also capable of over-the-air (OTA) communication. A representative example of a mobile device employing principles of the present invention is illustrated in FIG. 9.

The representative mobile device 900 utilizes computing circuitry to control and manage the conventional device activity as well as the functionality provided by the present invention. For example, the illustrated mobile device 900 includes a processing/control unit 902, such as a microprocessor, reduced instruction set computer (RISC), or other central processing module. The processing unit 902 need not be a single device, and may include one or more processors. For example, the processing unit may include a master processor and associated slave processors coupled to communicate with the master processor.

The processing unit 902 controls the basic functions of the mobile device 900 as dictated by programs available in the program storage/memory 904. The storage/memory 904 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the mobile device. The storage 904 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile device operations in accordance with the present invention may also be transmitted to the mobile device 900 via data signals, such as being downloaded electronically via one or more networks, such as the Internet and an intermediate wireless network(s).

For performing other standard mobile device functions, the processor 902 is also coupled to user-interface 906 associated with the mobile device 900. The user-interface (UI) 906 may include, for example, a display 908 such as a liquid crystal display, a keypad 910, speaker 912, and microphone 914. These and other UI components are coupled to the processor 902 as is known in the art. The keypad 910 may include alpha-numeric keys for performing a variety of functions, including dialing numbers for conventional, default cellular communication, and/or effecting auxiliary radio communication. Other UI mechanisms may be employed, such as voice commands, switches, touch pad/screen, graphical user interface using a pointing device, trackball, joystick, or any other user interface mechanism.

The wireless device 900 may also include conventional circuitry for performing wireless transmissions over the mobile network. The DSP 916 may be employed to perform a variety of functions, including analog-to-digital (A/D) conversion, digital-to-analog (D/A) conversion, speech coding/decoding, encryption/decryption, error detection and correction, bit stream translation, filtering, etc. The default transceiver 918, generally coupled to an antenna 920, transmits the outgoing radio signals 922 and receives the incoming radio signals 924 associated with the mobile device 900. For example, signals 922, 924 may represent the message exchange to initiate auxiliary radio communication in accordance with the present invention. This message exchange may be conducted via a Radio Access Network (RAN) associated with a cellular network, such as Global System for Mobile communications (GSM), Universal Mobile Telecommunications System (UMTS), Personal Communications Service (PCS), Time Division Multiple Access (TDMA), Code Division Multiple Access (CDMA), or other mobile network transmission technology.

In accordance with the present invention, the communicating mobile devices include at least one auxiliary radio communication interface, or an auxiliary mode of operation of the default radio interface. The illustrated embodiment includes a Bluetooth transceiver 930 for communicating via Bluetooth standards. A wireless LAN (WLAN) transceiver 932 provides for wireless communication via a local wireless network, such as in accordance with IEEE 802 standards. Any other auxiliary radio communication interface may instead, or in addition, be used in accordance with the present invention, as depicted by the respective transceiver 934.

It should be noted that any of the transceivers illustrated in FIG. 9 may be implemented as a modular transceiver including both transmitting and receiving circuitry, or any of such transceivers may alternatively be implemented as discrete transmitter and receiver circuits. As used herein, a “transceiver” is intended to describe circuits or other modules for wirelessly transmitting and receiving information, regardless of whether the transmitter and receiver circuits are discrete components or collectively provided in a single package.

In the illustrated embodiment, the storage/memory 904 stores the various client programs and data associated with the present invention. For example, the storage 904 includes an auxiliary interface enable module 936, which may include program instructions for enabling power to a particular one or more of the auxiliary radio communication interfaces. For example, a message received via the default radio interface may identify Bluetooth as the desired auxiliary radio interface. The auxiliary interface enable module 936 recognizes that Bluetooth is the desired auxiliary radio interface, and together with the processing unit 902 may power on, or otherwise enable for communication, the Bluetooth-related circuitry such as the Bluetooth transceiver 930 to enable its operation. It should be recognized that additional hardware (not shown) to enable power to such transceivers 930, 932, 934 may also be implemented.

In addition to the various transceiver circuits 930, 932, 934, associated software modules may be provided to assist in the operation of the particular auxiliary radio communication methodology employed. For example, where Bluetooth is the desired auxiliary radio interface, a Bluetooth program module 938 may include software operable via the processing unit 902 and operable to communicate information via the Bluetooth transceiver 930. Similarly, a WLAN module 940 may include program instructions operable via the processing unit 902 and operable to communication information via the WLAN transceiver 932. The storage/memory 904 may also include a policy processing module 942 for processing policies 944. A parameter processing module 946 may be provided to process parameters 948 that may be received via the messages and/or stored at the storage/memory 904.

As previously indicated, the auxiliary communication information may be sent from one communication device to another communication device(s) via a default radio communication channel. This includes, for example, sending the auxiliary communication information via a GSM/GPRS, TDMA, CDMA, PCS, or any other cellular network infrastructure. When communicating such auxiliary communication information from one communication device to another, the information traverses the network, and involves one or more network elements or intermediaries. For example, an auxiliary radio communication initiation message(s) may be communicated between GPRS Support Nodes (GSNs), such as between GGSNs and/or SGSNs, using a GPRS Packet Data Protocol (PDP) message(s) where a GPRS network 222 is employed. Or, the auxiliary information may be included in user data packets carried by way of the GPRS Tunneling Protocol (GTP), IP packets, and the like.

These network elements are operable in the network, and facilitate communication between the communicating devices. Such a network element may include a receiver coupled to a first communication device via the network to receive the auxiliary communication information from the first communication device according to a primary over-the-air (OTA) communication mode. This primary OTA communication mode may include, for example, transmissions via layer-2 such as Wireless Ethernet MAC sublayer transmissions, Bluetooth MAC sublayer transmissions, GPRS PDP transmissions, etc. The information may also be transmitted via internet layer transmissions, such as via IP packets and/or IP options associated with IP packets, messaging or signaling methodologies, such as via SMS, MMS, Smart Messaging, SIP, IM protocol or service, presence sharing protocol, etc. These are merely representative of default/primary OTA communication channels that may represent the primary OTA communication mode. The auxiliary communication information represents an invitation from the first communication device targeted for the second communication device to activate an auxiliary OTA communication mode for communication between the first and second communication devices. The network element also includes a transmitter coupled to the second communication device via the network to transmit the auxiliary communication information to the second communication device according to the primary OTA communication mode. In this manner, the first and second communication devices are enabled for communication according to the auxiliary OTA communication mode in response to the second communication device receiving the auxiliary communication information. It should be noted that the receiver and transmitter may be implemented separately, or collectively as a transceiver module.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

1. A method for communicating between devices, comprising:
communicating auxiliary communication information from at least one initiating device to at least one target device via a first over-the-air (OTA) communication interface; and
in response to the auxiliary communication information, activating an auxiliary communication module at the at least one target device for communication via a second OTA communication interface.

2. The method of claim 1, further comprising the target device communicating via the second OTA communication interface.

3. The method of claim 2, wherein the target device communicating via the second OTA communication interface comprises the target device communicating with at least the initiating device via the second OTA communication interface.

4. The method of claim 2, wherein the target device communicating via the second OTA communication interface comprises the target device communicating with at least one device different than the initiating device.

5. The method of claim 1, wherein communicating auxiliary communication information from at least one initiating device to at least one target device via a first OTA communication interface comprises transmitting the auxiliary communication information from the at least one initiating device to at least one target device via a cellular network.

6. The method of claim 1, wherein the first OTA communication interface comprises a default interface available for communication at any time that the initiating and target devices are powered on.

7. The method of claim 1, wherein communicating auxiliary communication information from at least one initiating device to at least one target device via a first OTA communication interface comprises transmitting at least information instructing the target device to enable the auxiliary communication module for communication at the target device.

8. The method of claim 1, wherein communicating auxiliary communication information from at least one initiating device to at least one target device via a first OTA communication interface comprises transmitting at least information inviting the target device to enable for communication a plurality of auxiliary communication modules at the target device.

9. The method of claim 1, wherein communicating auxiliary communication information from at least one initiating device to at least one target device via a first OTA communication interface comprises transmitting at least information inviting the target device to initiate communications with the initiating device via the second OTA communication interface.

10. The method of claim 1, wherein the first OTA communication interface comprises infrastructure-based network interface.

11. The method of claim 1, wherein the second OTA communication interface comprises a proximity-based network interface.

12. The method of claim 1, wherein the second OTA communication interface comprises one or more wireless interfaces associated with an ad-hoc network.

13. The method of claim 12, wherein the communication via the one or more wireless interfaces associated with the ad-hoc network comprises communication over multiple hops of the ad-hoc network using the one or more wireless interfaces.

14. The method of claim 1, wherein the first OTA communication interface comprises a communication interface in which OTA communication is effected via a portion of a licensed frequency spectrum, and wherein the second OTA communication interface comprises a communication interface in which OTA communication is effected via a non-licensed frequency spectrum.

15. The method of claim 1, wherein communicating auxiliary communication information from at least one initiating device to at least one target device via a first OTA communication interface comprises transmitting the auxiliary communication information from the initiating device to the at least one target device via one or more data link layer transmissions.

16. The method of claim 15, wherein the data link layer transmissions comprise any of Wireless Ethernet Media Access Control (MAC) sublayer transmissions, Bluetooth MAC sublayer transmissions, General Packet Radio Service (GPRS) Packet Data Protocol (PDP) transmissions, or transmission via GPRS Tunneling Protocol (GTP).

17. The method of claim 1, wherein communicating auxiliary communication information from at least one initiating device to at least one target device via a first OTA communication interface comprises transmitting the auxiliary communication information from the initiating device to the at least one target device via one or more internet layer transmissions.

18. The method of claim 17, wherein the internet layer transmissions comprise Internet Protocol (IP) packet transmissions.

19. The method of claim 17, wherein the internet layer transmissions comprise Internet Protocol (IP) options associated with one or more IP packet transmissions.

20. The method of claim 1, wherein communicating auxiliary communication information from at least one initiating device to at least one target device via a first OTA communication interface comprises transmitting the auxiliary communication information from the initiating device to the at least one target device via a messaging technology.

21. The method of claim 20, wherein transmitting the auxiliary communication information from the initiating device to the at least one target device via a messaging technology comprises transmitting the auxiliary communication information via any one or more of a Short Message Service (SMS), Multimedia Messaging Service (MMS), Smart Messaging, Instant Messaging (IM) protocol or service, or presence sharing protocol.

22. The method of claim 1, wherein communicating auxiliary communication information from at least one initiating device to at least one target device via a first OTA communication interface comprises transmitting the auxiliary communication information from the initiating device to the at least one target device via Session Initiation Protocol (SIP) methods.

23. The method of claim 1, wherein communicating auxiliary communication information comprises transmitting auxiliary communication parameters for controlling communications over the second OTA communication interface.

24. The method of claim 23, wherein transmitting auxiliary communication parameters comprises transmitting address information of one or more of the initiating and target devices.

25. The method of claim 23, wherein transmitting auxiliary communication parameters comprises transmitting location information of one or more of the initiating and target devices.

26. The method of claim 23, wherein transmitting auxiliary communication parameters comprises transmitting timing information related to a start-up or synchronization of the auxiliary communication module of the target device.

27. The method of claim 23, wherein transmitting auxiliary communication parameters comprises transmitting radio technology identification information related to a radio technology identified for use via the second OTA communication interface.

28. The method of claim 23, wherein transmitting auxiliary communication parameters comprises transmitting radio channel or coding information associated with the second OTA communication interface.

29. The method of claim 23, wherein transmitting auxiliary communication parameters comprises transmitting timeout information indicative of an allowable time in which the target device attempts to establish communications via the second OTA communication interface.

30. The method of claim 23, wherein transmitting auxiliary communication parameters comprises transmitting one or more of security and authentication information.

31. The method of claim 1, further comprising applying at least one policy at the target device that affects a manner in which the communication via the second OTA communication interface is to be effected.

32. The method of claim 1, further comprising applying at least one policy at the target device to determine whether activation of the auxiliary communication module identified by the auxiliary communication information will be effected.

33. The method of claim 32, further comprising continuing at least some communication via the first OTA communication interface in response to applying the at least one policy.

34. The method of claim 32, further comprising rejecting the activation of the auxiliary communication module if the auxiliary communication module at the target device is not compatible with the auxiliary communication interface identified by the auxiliary communication information communicated via the first OTA communication interface.

35. A method for facilitating network communications via a mobile device, comprising:
receiving at least one message at the mobile device via a default radio interface, wherein the at least one message includes proximity communication information;
identifying the proximity communication information at the mobile device;
enabling at least one wireless proximity communication interface or at least one auxiliary mode of operation of the default radio interface in response to the identified proximity communication information; and
wirelessly communicating between the mobile device and at least one other communication device via an enabled one or more of the wireless proximity communication interface or auxiliary mode of operation of the default radio interface.

36. The method of claim 35, wherein the default radio interface comprises an infrastructure-based radio interface.

37. The method of claim 35, wherein receiving at least one message at the mobile device via an infrastructure-based radio interface comprises receiving the at least one message via a cellular network.

38. The method of claim 37, wherein receiving the at least one message via the cellular network comprises receiving the proximity communication information via any of a layer-2 transmission, Wireless Ethernet MAC, Bluetooth MAC, GPRS PDP message, internet layer transmission, IP packet, SMS message, MMS message, Smart Message, SIP message, or application layer message.

39. The method of claim 35, wherein identifying the auxiliary communication information comprises parsing the at least one message received at the mobile device and recognizing the auxiliary communication information within the at least one message.

40. The method of claim 35, further comprising comparing at least some of the proximity communication information with one or more policies available at the mobile terminal, and wherein enabling at least one wireless proximity communication interface comprises enabling the at least one wireless proximity communication interface based on a result of the comparison of the at least some of the proximity communication information and the one or more policies.

41. The method of claim 35, wherein enabling at least one wireless proximity communication interface comprises applying power to a wireless proximity communication module associated with the wireless proximity communication interface.

42. The method of claim 35, wherein enabling at least one wireless proximity communication interface comprises initiating, at the mobile device, wireless communication with the at least one other communication device via the wireless proximity communication interface.

43. The method of claim 35, wherein wirelessly communicating comprises communicating over-the-air via at least one of a Wireless Local Area Network (WLAN) and a Bluetooth network.

44. A communication device for communicating over-the-air (OTA), comprising:
at least one default radio communication module configured for at least first wireless communication via a first radio communication interface;
at least one auxiliary radio communication module capable of effecting second wireless communication via a respective auxiliary radio communication interface; and
a processing module configured to receive auxiliary communication information via the first radio communication interface, and to activate the auxiliary radio communication module identified by the auxiliary communication information for communication via the respective auxiliary radio communication interface or an auxiliary mode of operation of the first radio communication interface.

45. The communication device of claim 44, wherein the processing module comprises an auxiliary interface enable module configured to enable the respective auxiliary radio communication interface for communication in response to the auxiliary communication information.

46. The communication device of claim 44, wherein the processing module comprises a policy processing module configured to process policies stored at the communication device and to make decisions affecting at least the second wireless communication based on the policies.

47. The communication device of claim 44, wherein the processing module comprises a parameter processing module configured to process parameters associated with the auxiliary communication information, and to configure the respective auxiliary radio communication interface based at least in part on the processed parameters.

48. The communication device of claim 44, wherein:
the at least one default radio communication module comprises a first receiver coupled OTA to an initiating device to receive at least the auxiliary communication information via the first radio communication interface; and
the at least one auxiliary radio communication module comprises a transceiver for communicating via the auxiliary radio communication interface.

49. The communication device of claim 44, further comprising an activate circuit coupled to the processing module and to the auxiliary radio communication module, wherein the processing module is further configured to activate the auxiliary radio communication module identified by the auxiliary communication information by providing one or more signals to the activate circuit, and wherein the activate circuit provides battery power to the auxiliary radio communication module in response to the one or more signals.

50. The communication device of claim 44 wherein the communication device comprises any of a mobile phone, Personal Digital Assistant (PDA), wireless communication device, mobile computing system, and fixed wireless computing system.

51. The communication device of claim 44 wherein the communication device comprises a computing system capable of over-the-air (OTA) communication via the first and second radio communication interfaces.

52. A system for communicating information between devices, comprising:
an initiating communication device;
a recipient communication device coupled to communicate over a default over-the-air (OTA) interface with the initiating communication device to receive auxiliary communication information from the initiating communication device, the recipient communication device comprising:
a first communication module configured for first wireless communication via the default OTA interface;
at least one auxiliary communication mode capable of effecting second wireless communication; and
a processing module configured to receive the auxiliary communication information via the first communication module over the default OTA interface, and to activate the auxiliary communication mode identified by the auxiliary communication information for communication via the second wireless communication.

53. The system as in claim 52, wherein the at least one auxiliary communication mode comprises at least one auxiliary mode of operation capable of effecting the second wireless communication via the default OTA interface.

54. The system as in claim 52, wherein the at least one auxiliary communication mode comprises at least one auxiliary communication module capable of effecting the second wireless communication via a respective auxiliary OTA interface.

55. The system as in claim 54, wherein the processing module comprises an auxiliary interface enable module to apply power to the at least one auxiliary communication module in connection with the activation of the at least one auxiliary communication module.

56. The system as in claim 54, wherein the initiating communication device comprises:
a first initiating communication module configured for the first wireless communication via the default OTA interface;
at least one initiating auxiliary communication module capable of effecting the second wireless communication via the respective auxiliary OTA interface; and
an auxiliary interface information generation module to generate the auxiliary communication information for transfer to the recipient communication device via the default OTA interface.

57. The system as in claim 52, wherein the recipient communication device comprises any of a mobile phone, handset communication device, fixed wireless communication device, Personal Digital Assistant (PDA) and portable computing device.

58. The system as in claim 52, wherein the initiating communication device comprises any of a mobile phone, handset communication device, fixed wireless communication device, Personal Digital Assistant (PDA) and portable computing device.

59. A computer-readable medium having instructions stored thereon which are executable by a computer system for enabling auxiliary radio communications via a communications device by performing steps comprising:
identifying proximity communication information associated with one or more messages received at the communications device via an infrastructure-based radio interface;
enabling a wireless proximity communication interface for over-the-air communication in response to the identified proximity communication information; and
facilitating wireless communications between the communications device and at least one other communication device via the wireless proximity communication interface.

60. A communication device capable of communicating over-the-air (OTA), comprising:
means for receiving auxiliary communication information at the communication device via a default radio interface;
means for enabling at least one of an auxiliary communication interface or an auxiliary mode of operation of the default radio interface at the communication device in response to the auxiliary communication information; and
means for communicating OTA between the communication device and at least one other communication device via an enabled one or more of the auxiliary communication interface or the auxiliary mode of operation of the default radio interface.

61. A method for communicating between devices, comprising:
communicating auxiliary communication information from at least one initiating device to at least one target device via a first communication mode of an over-the-air (OTA) communication interface; and
in response to the auxiliary communication information, activating an auxiliary communication mode at the at least one target device for communication via the auxiliary communication mode of the OTA communication interface.

62. The method of claim 61, wherein communicating auxiliary communication information from at least one initiating device to at least one target device comprises transmitting at least information inviting the target device to initiate communications with the initiating device via the auxiliary communication mode of the OTA communication interface.

63. A network element operable in a network for facilitating communication between at least first and second communication devices, the network element comprising:
a receiver coupled to the first communication device via the network to receive auxiliary communication information from the first communication device according to a primary over-the-air (OTA) communication mode, wherein the auxiliary communication information represents an invitation from the first communication device targeted for the second communication device to activate an auxiliary OTA communication mode for communication therebetween; and
a transmitter coupled to the second communication device via the network to transmit the auxiliary communication information to the second communication device according to the primary OTA communication mode, whereby the first and second communication devices are enabled for communication according to the auxiliary OTA communication mode in response to the second communication device receiving the auxiliary communication information.
